(19) United States
(12) Patent Application Publication
(10) Pub. No.: US 2020/0213642 A1
(43) Pub. Date: Jul. 2, 2020

(54) SYSTEMS AND METHODS FOR PLAYNG VIDEOS WITH BACKGROUND LOADING

(71) Applicant: LongTail Ad Solutions, Inc., New York, NY (US)

(72) Inventors: John BARTOS, Brooklyn, NY (US); Robert WALCH, New York, NY (US)

(21) Appl. No.: 16/233,371

(22) Filed: Dec. 27, 2018

(51) Int. Cl. H04N 21/234; H04N 21/6587; H04N 21/431; H04N 21/81; G06F 16/432

(52) U.S. Cl. CPC H04N 21/23406; H04N 21/23424; G06F 16/432; H04N 21/4316; H04N 21/812; H04N 21/6587

(57) ABSTRACT

Systems and methods for playing videos and video advertisements utilize background loading techniques to shorten any delay between the time that a first video finishes playing and the time that a subsequent video begins playing. These techniques can be utilized when videos are playing automatically, one after another. These techniques also can be used when videos and video advertisements are playing in an alternating fashion.

### BACKGROUND

In many instances, a website publisher who creates a website derives revenue not from use of the website, but rather from advertisers who place advertisements on the website. Advertisements can take the form of display or banner advertisements, which are typically static images that are placed in various locations on a webpage. If a user viewing the website wishes to obtain more information about an advertisement, the user would typically select or click upon the display advertisement, and the user's browser software application would then navigate to and load a website run by the advertiser.

More recently, it has become common for websites to offer video content. Typically, a webpage will include one or more embedded video players, and each of the embedded video players is configured to play a different video. Because a video player is present on the webpage, it is possible for the website publisher to play video advertisements to users.

In some instances, when a user issues a play command, asking to watch a particular video, the video player first loads and plays a video advertisement. Once the video advertisement is finished, the video content that the user originally intended to view is played.

In other instances, particularly when a video is lengthy, play of a video will be paused partway through, and a short video advertisement is played to the user. Once the video advertisement finishes, play of the main video content resumes.

A website publisher will seek to maximize the number of video advertisements that can be played to a user because this maximizes the amount of revenue he will receive from the advertisers. Various factors can influence how many video advertisements can be played to a user, but the primary factor is keeping the user's attention. So long as the user remains on the webpage and continues to watch video content, additional video advertisements can be played to the user.

One of the issues that can cause a user to navigate away from a website is any delay in playing a requested video. If the user is forced to wait for video content to load before it plays, the user may become impatient and simply switch to a different webpage that can play videos more rapidly after a play command is issued. This can be particularly problematic if the content which is taking too long to load is a video advertisement that plays before desired video content.

A related problem occurs when a user is watching a series of videos that are being played to the user. If autoplay functionality has been enabled, then when a first video ends, a second video will be automatically loaded and played without further user intervention. However, the user may be played a video advertisement between the first and second videos. If the first video ends and the user must wait for the video advertisement to load before the video advertisement is played, there is a danger that the user will become bored and that he will simply navigate away to a different webpage. Similarly, if a video advertisement plays, but the user is then forced to wait while the second video loads, the user can become bored and navigate away to a different webpage.

For all the above-described reasons, website publishers would like to eliminate, as much as possible, any delay between the play of a first video or video advertisement and the play of a second video or video advertisement. As explained above, operating in that fashion helps to keep the user on an existing webpage so that additional advertisements can be displayed or played to the user, thereby maximizing advertising revenue.

### BRIEF DESCRIPTION OF THE DRAWINGS

FIG. 1 is a diagram illustrating a communications environment in which systems and methods embodying the invention can be performed;

FIG. 2 is a diagram of selected elements of a video player software application;

FIG. 3 is a diagram of selected elements of a media element that would be used to play a media item;

FIG. 4 is a flowchart illustrating steps of a method of playing media items that make use of background loading;

FIGS. 5A & 5B show a flowchart illustrating steps of a method of playing media items and advertising media items that makes use of background loading;

FIGS. 6A and 6B show a flowchart illustrating steps of a second method of playing media items and advertising media items that makes use of background loading; and

FIG. 7 is a diagram illustrating elements of a computer system and associated peripherals which could embody various aspects of the invention.

### DETAILED DESCRIPTION

The invention is primarily embodied in video player software applications that would be instantiated during rendering of a webpage, and in the methods that such video software applications perform. However, aspects of the invention can also be found in other software applications and the methods that those software applications perform.

We will first establish the meaning of certain terms that will be used throughout the following descriptions.

A media player software application might also be referred to simply as a “video player”, or just a “player.” This is a software application that is responsible for playing “media items” to a user. A single webpage may include multiple instantiations of a video player, and a different media item could be loaded into each instantiation of the video player.

A “media item” could be a video or an audio clip. An “advertising media item” could be a video advertisement or an audio advertisement. Elements of a video player can obtain media items and advertising media items from many different sources, some of which are described below.

Typically, when a user issues a play command, the video player begins to load a media item into a playback buffer memory. The contents of the playback buffer memory are then read out and used to play the media item. Often a video player will not begin to play a media item until a sufficient portion of the media item has been loaded into the playback buffer memory such that play of the media item can proceed without interruption, even if there are small delays in loading the remaining portions of the media item into the playback buffer memory.

A “media element” is used to control the play of a media item. A media element must be attached to the “foreground” of the video player or webpage before the media element can play a video or audio clip to a user. The foreground can also be called the DOM, which stands for the Document Object Model. For purposes of the following description, we will refer to attaching a media element to the foreground, and detaching the media element from the foreground. Detaching a media element from the foreground could also be equivalent to attaching the media element to the background. This action could also be expressed as attaching the media element to the DOM, and detaching the media element from the DOM.

A single video player could have multiple media elements, each of which is responsible for the play of a different media item. As noted above, only one of the media elements can be attached to the foreground at any given point in time. Any other media elements associated with the video player would be detached from the foreground.

A media element can include a “media controller” which is responsible for playing a particular media item or advertising media item. A media element can also be given or assigned a “media tag,” which is typically a piece of software code, a URL, or some other piece of data or code that can be used to obtain a media item from a source.

In some instances, a media element can also include a “media model,” which can include information that is used by the media controller to properly format and play a media item. A media element may also include a “provider” that is responsible for obtaining a media item using a media tag.

In the following description, we refer to both a media element, and an advertising media element. An advertising media element is simply a media element that is configured to play a media item that is an advertisement.

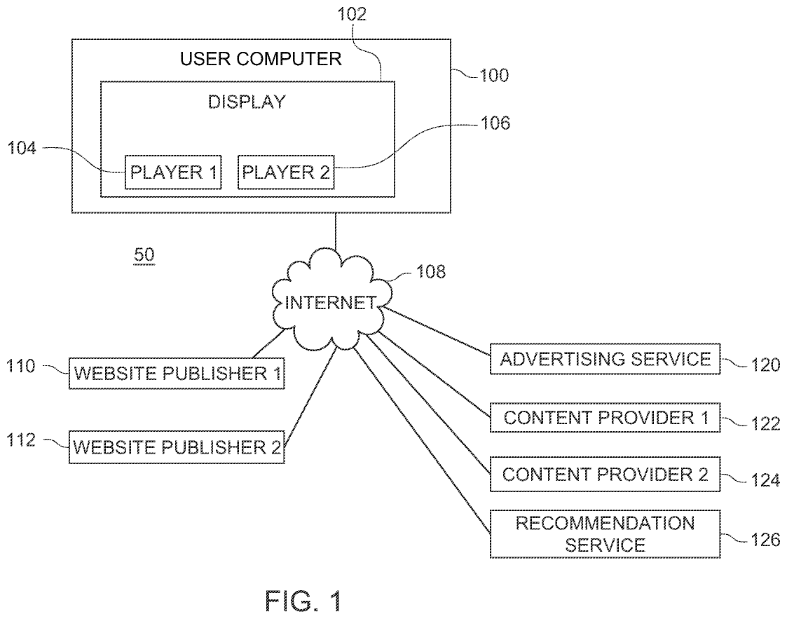

FIG. 1 illustrates a communications environment 50 in which a video player software application embodying the invention could be used. As shown in FIG. 1, a user computing device 100 includes a display 102. An Internet browser software application loads and renders webpages of websites using information obtained from the Internet 108. In rendering a webpage, the browser could instantiate a first video player 104 and a second video player 106 that appear in separate windows in the webpage depicted on the display 102.

A first website publisher 110 and a second website publisher 112 provide websites that are accessible via the Internet 108. The website publishers 110/112 could host their websites on internal servers that are connected to the Internet 108. Alternatively, the website publishers could host their websites on cloud-based servers and memory devices that also are attached to the Internet 108. While only two website publishers 110/112 are illustrated in FIG. 1, those of ordinary skill in the art will appreciate that there are actually a very large number of website publishers that provide websites via the Internet 108.

An advertising service 120 connected to the Internet 108 can provide advertisements to websites. As noted above, those advertisements could include banner or display advertisements, or video advertisements. Often a website publisher 110/120 will enter into a contractual arrangement with an advertising service 120 under which an advertising service 120 provides advertisements to the websites created and maintained by the website publisher. The advertising service 120, in turn, enters into contractual arrangements with a variety of businesses that wish to place advertisements on websites. Thus, the advertising service 120 acts as a middleman between the website publishers and the advertising businesses. The advertising businesses pay the advertising service 120 to get their advertisements on websites, and the advertising service pays the website publishers 110/112 to place advertisements on the websites created and maintained by the website publishers.

A first content provider 122 and a second content provider 124 provide media items that can be displayed/played on websites created and maintained by the website publishers 110/112. For example, the first content provider 122 could provide a library of videos that relate to a first topic, for example sports. The second content provider 124 could provide a library of videos that relate to a different topic, such as nature videos. The website publishers 110/112 would pay the content providers 122/124 to play the videos the content providers 122/124 have in their respective libraries. While FIG. 1 only illustrates two content providers, those of ordinary skill in the art will appreciate that there are actually a very large number of content providers that provide all sorts of different media items.

A recommendation service 126 may be part of a content provider, or the recommendation service 126 could be a stand-alone entity. The recommendation service 126 provides recommendations regarding media items to the website publishers 110/112. The recommendations could come in many forms. However, the recommendations are designed to provide information to the website publishers that they can use to place desirable media items on their websites. In many instances, recommendations are automatically generated using algorithms, and thus require no human intervention.

For example, a recommendation could be that if a particular user appeared to like media item X, then the same user will likely find media items A, B and C interesting. Armed with that recommendation, a website publisher could offer media item X on one of its webpages. If a user watches media item X to completion, then the website could offer to play the user media items A, B and C. Thus, the recommendations could be used to setup a playlist for a particular instantiation of a video player. Such recommendations might also be used in real time to respond to what a particular user seems to find interesting.

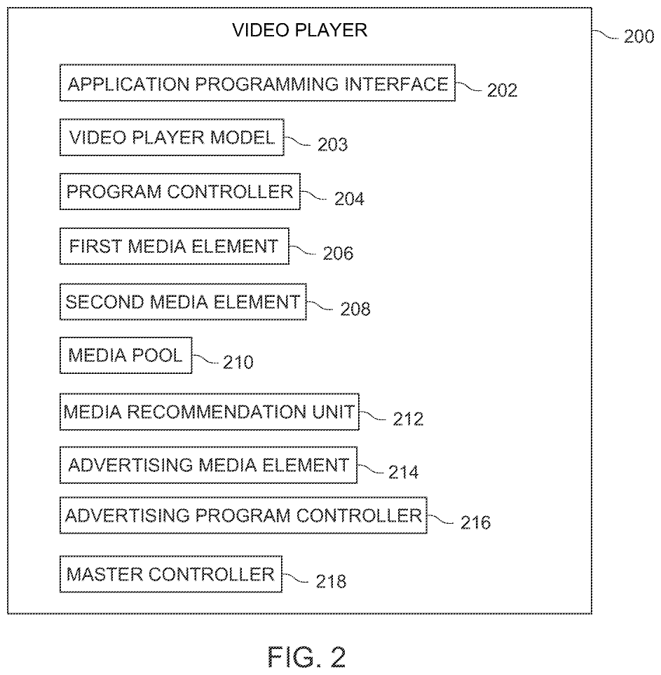

With the above background, we will now discuss the elements of a video player 200, as illustrated in FIG. 2. As explained above, a video player 200 would be instantiated as a web browser renders a webpage. A single webpage could have multiple instantiations of a video player software application, with a different media item initially loaded into each instantiation. It is common for the video player to appear as a window embedded in the webpage. A still image and/or title relating to the media item that is initially loaded in the video player can appear in the player's window to inform the user of what is loaded. It has also become possible for a user to place or hover a cursor within the window of the video player to cause a very short clip of the video to play, which provides a preview of what is contained in the media item.

As illustrated in FIG. 2, the video player 200 includes an application programming interface (API) 202 which can be used to control the video player, and which can also be used to obtain information and event notifications from the video player 200. For example, the API 202 can be used to establish or vary various settings on the video player 200, such as the size of the player, the resolution at which a media item is played, a volume setting, a language setting, as well as various other settings which could be relevant to one or more media items. The API 202 could also report various items of information, such as a time count as a media item is played, a time to the end of the media item, the degree to which a media item has been downloaded to the playback buffer memory, as well as various other items.

A video player model 203 includes information about various settings of the video player 200, and information about how media items are to be played.

The depiction in FIG. 2 shows that the video player 200 includes a first media element 206, a second media element 208 and an advertising media element 214. Each of these media elements 206/208/214 initially is loaded with a media tag for a media item. However, in any given instantiation of a video player 200 there could be fewer than these three media elements, or additional media elements. Thus, the depiction in FIG. 2 should in no way be considered limiting. How these media elements 206/208/214 are controlled to play media items for a user is discussed in detail below.

The video player 200 also includes a program controller 204 and an advertising program controller 216. The program controller 204 is responsible for attaching either the first media element 206 or the second media element 208 to the foreground and for detaching the first and second media elements 206/208 from the foreground. The program controller 204 may also instruct the first and second media elements 206/208 about when and how to play a media item. The advertising program controller 216 is responsible for attaching the advertising media element 214 to the foreground and for detaching the advertising media element 214 from the foreground. The advertising program controller 216 may also instruct the advertising media element 214 about when and how to play an advertising media item.

As noted above, only one media element 206/208/214 can be attached to the foreground at any given point in time. Coordination of attaching and detaching of media elements to the foreground may be carried out by a master controller 218 that sends instructions to the program controller 204 and the advertising program controller 216.

The video player 200 also includes a media pool 210. The media pool 210 includes not the media items themselves, but rather a pool of media tags. As explained above, the media tags are small pieces of computer code, or URLs or other items in information that enable the video player to obtain a media item from the location at which it is stored.

The video player 200 further includes a media recommendation unit 212 which is used to select various media items for play. In some instances, the media recommendation unit 212 could include a list of media items or media tags of media items that can be used to select media items for play by the video player 200. The media recommendation unit 212 could obtain media item recommendations from a recommendation service 126. The media recommendation unit 212 might also interact with a recommendation service 126 in real time, based on the behavior or course of conduct of a user to try to play media items, to select media items that the user likely will find interesting.

In some embodiments, the media recommendation unit 212 could be somewhat interactive. For example, if a user allows the video player 200 to play media item X through to completion, this could indicate that the user found media item X interesting. In that case, the media recommendation unit 212 could instruct the master controller 218 to cause media item A to be played to the user, where media item A is similar in content to media item X, such that one would expect the user to also find media item A interesting. Alternatively, if the user halts play of video X after only a short period of time, the media recommendation unit 212 could instruct the master controller 218 to cause media item C to be loaded and played, where media item C is different in content from media item X.

The ways in which the video player can play media items to a user are discussed in detail below. However, one of ordinary skill in the art will appreciate that a particular instantiation of a video player 200 could include may other items in addition to those shown in FIG. 2, and that a particular instantiation of a video player might not include all the items illustrated in FIG. 2. Thus, the depiction in FIG. 2 should in no way be considered limiting.

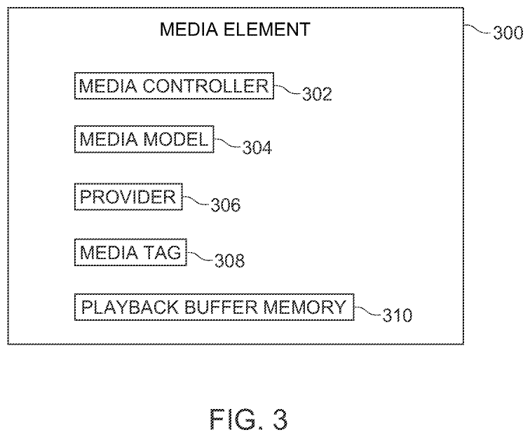

FIG. 3 illustrates selected portions of a media element 300. The media element 300 includes a media controller 302 that would cause the play of a media item. The media controller 302 may format the media item based on information in a media model 304. The media model 304 could include various items of information that are used to control how a media items is played to a user. Settings within the media model 304 could be synchronized with corresponding settings in the video player model 203 of the video player 200.

A provider 306 could be used to obtain a media item based on a media tag 308. As noted above, the media tag 308 could be a portion of computer code, a URL or some other piece of information that can be used to obtain a specific media item. Typically, the media item would be stored on a server accessible via a data network such as the Internet 108, and the information provided in the media tag 308 enables the provider 306 to locate and download the media item. Note, the information in the media tag 308 of a media element 300 could be changed at any time. However, when the media controller 302 is instructed to begin playing a media item, it is the media item identified in the currently loaded media tag 308 that will be obtained and played.

The media item 300 could also include a playback buffer memory 310 which is used to download and temporarily hold a media item. In some embodiments, a playback buffer memory 310 will be associated with a particular media element. In other embodiments, the media element 300 may be associated with a playback buffer memory that is not necessarily considered a part of the media element 300

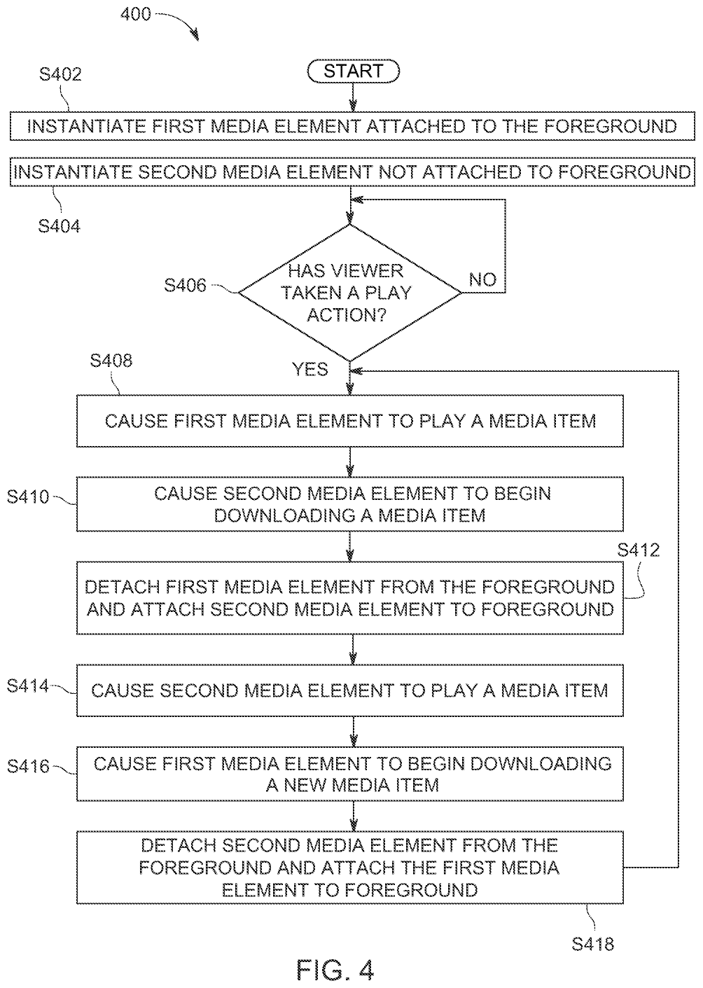

With the foregoing as background, we will now turn to a discussion of some methods embodying the invention that could be performed by a video player 200 embodying the invention. We will start with the method depicted in FIG. 4. In this method, two media elements are used to play a series of media items. Background loading techniques are used to ensure that there is little or no time delay between when a first media item finishes playing and when a second media item begins to play.

The method 400 begins and proceeds to step S402 where a video player 200 instantiates a first media element 300 that is attached to the foreground. The instantiation procedures could include loading a first media tag 308 in the first media element 300. The instantiation procedures could also include configuring certain settings of the video player and/or the first media element 300. The setting of the first media element 300 may be established according to a media model 304 of the first media element 300.

The method then proceeds to step S404, where a second media element 300 is instantiated. The second media element 300 is not attached to the foreground. A second media tag 308 would be loaded in the second media element 300.

The method then proceeds to step S406, where a check is performed to determine whether a user has taken a play action or issued a play command. As noted above, selecting a play icon or button within the media player window is one common way for a user to issue a play command. However, many other gestures might also satisfy the requirement for the user to issue a play command. In some instances, the user could take a certain action on a portion of the webpage that does not include the video player, and that action could be construed as the issuance of a play command. What qualifies as a play command will be determined by the browser software application that is being used.

If the user has already issued a play command, the method proceeds to step S408. If not, the method waits until the user takes an action that can be construed as issuance of a play command, at which point the method proceeds to step S408.

In step S408 a media controller 302 of the first media element that is attached to the foreground begins to play a first media item identified in the media tag 308 of the first media element. This can include beginning to download the data of the media item into a first playback buffer memory 310 that is a part of the first media element or which is associated with the first media element. The media item could then be played using the data loaded in the first playback buffer memory 310. In other embodiments, the media item may simply be streamed without buffering in a memory. Note, the playback buffer memory 310 may not be a part of the first media element.

While the first media item is playing, the method proceeds to step S410, and the second media element begins to load the media item identified by the media tag 308 of the second media element into a second playback buffer memory 310 that is either a part of or associated with the second media element. The point in time at which the method proceeds to step S410, and the second media element begins to load a media item into the second playback buffer memory 310 can vary based on a number of factors, and/or based on how the video player is configured.

It is desirable to begin loading the new media item into the second playback buffer memory early enough such that when the first media element finishes playing the first media item, there is enough of the new media item in the second playback buffer memory that play of the new media item can begin immediately after the first media item finishes playing, and such that play of the new media item can proceed without interruption. By monitoring the rate at which the video data can be downloaded, and by determining the amount of data that needs to be downloaded so that play of the new media item can proceed without interruption, one can determine how much time will be required to download the required amount of the new media item. So, for example, if the amount of time required is two seconds, then the method will proceed to step S410 two seconds before the first media item is expected to end.

That said, other factors may also play into when the method proceeds to step S410, and when downloading of the new media item begins. For example, downloading the new media item should not impair downloading and play of the first media item that is already being played by the first media element. Thus, in a situation where data download speeds are low, the method will not proceed to step S410 and downloading the new media item into the second playback buffer memory will not begin until all or a sufficient portion of the first media item has been downloaded into the first playback buffer memory.

Also, it is not always possible to know when play of the first media item by the first media element will end. One can know how much longer the first media item will take to complete if the user watches the first media item to completion, but the user may halt playback of the first media item before all of the first media item has been played. For this reason, the video player may monitor how long a particular user tends to watch media items. If a particular user tends to halt playback of a media item at the 50 second mark, then the video player may cause the method to proceed to step S410 so that downloading of the new media item into the second playback buffer memory can begin slightly before the 50 second mark of the first media item, regardless of the length of the first media item.

Note, the video player may be able to identify a particular user via various means. The video player may also be able to retrieve information about individual users from a central database of aggregated user characteristics. That central database of user characteristics could be associated with the recommendation service 126 depicted in FIG. 1. Also, the central database of user characteristics could be a part of an entity that creates and provides the video player software. In instances where a user can be identified, and where information about user characteristics are available, the video player 200 may obtain and utilize the user characteristics information for various purposes, including when to cause the method depicted in FIG. 4 to move on to step S410.

Although the above explanation identifies a few factors that could be used to determine when to proceed to step S410, so that downloading of the new media item can begin, there are various other factors and considerations that may be taken into account to determine when to proceed to step S410.

When the first media item finishes playing, either because the entire first media item has been played, or because the user halted play of the first media item, the method proceeds to step S412. In step S412 a program controller 204 of the video player 200 detaches the first media element from the foreground and attaches the second media element to the foreground. The method then proceeds to step S414 where the second media element begins to play the new media item that was at least partially loaded into the second playback buffer memory. If at least some of the new media item was loaded into the second playback buffer memory while the first media item was playing, it may be possible to start playing the new media item to the user as soon as the second media element is attached to the foreground. Different browsers require different amounts of the media item to be present in the playback buffer memory before play of the media item can begin. In many cases, enough of the new media item will have been downloaded into the playback buffer memory so that play of the new media item will immediately begin.

Note, many browser software applications allow a user play action or a user generated play command to be captured once and then used to play a series of media items in an autoplay fashion. Some browsers, however, require that the user issue a new play command each time that a new media item is to be played. If that is the case, background loading of the new media item is still helpful, as it ensures that playback of the new media item can begin the instant the user issues a new play command.

For purposes of the discussion of the method depicted in FIG. 4, we are assuming that the browser allows autoplay of multiple videos, such that the video player 200 can capture a single user issued play command and then play multiple media items. However, the method depicted in FIG. 4 is also applicable to instances where the user's browser software requires the user to issue a new play command each time that a new media item is to be played.

At some point in time, the video player will cause the method to proceed to step S416, where the first media item is caused to load a new media tag for a new media item, and where the new media item corresponding to the new media tag begins to download into the first playback buffer memory 310 associated with the first media element. The considerations that go into deciding when to proceed to step S416 so that downloading of a new media item into the first playback buffer memory begins are essentially the same considerations that are used to determine when to proceed to step S410. Thus, the discussion provided above with respect to step S410 applies also to when to proceed to step S416.

When playback of the new media item by the second media element ends, whether because the entire media element has been played or because the user has halted playback, the method proceeds to step S418. In step S418 the program controller 204 of the video player 200 detaches the second media element from the foreground, and attaches the first media element to the foreground. The method then loops back to step S408, and the first media element begins to play the new media item that began downloading into the first playback buffer memory in step S416.

The method would continue to repeat steps S408-S418 until the user halts play of all media items by the video player, or until the browser navigates to a new webpage, or until the user closes the browser, or until an error on the part of the video player or the browser halts play.

In the method described above, a new media item automatically begins to play each time that play of a preceding media item runs to completion, or when the user halts play of the preceding media item. In other embodiments, when play of a preceding media item ends or the user halts play of a preceding media item, a new media item will not be played until the user issues a new play command. Downloading of the new media item by a media element that is detached from the foreground might occur before or after the user halts play of the preceding media item. Also, when the user halts play of the preceding media item, the program controller 204 may detach the media element that was playing the preceding media item from the foreground and attach an alternate media element to the foreground. In that instance, downloading of the new media item by the media element that has just been attached to the foreground may proceed after the media element is attached to the foreground and before the user issues a new play command.

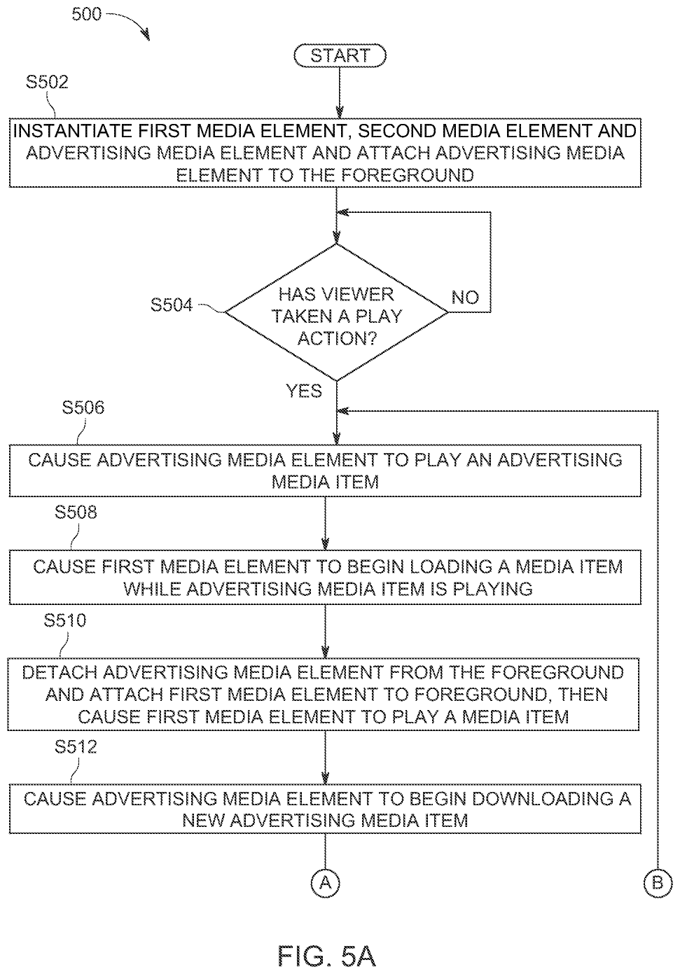

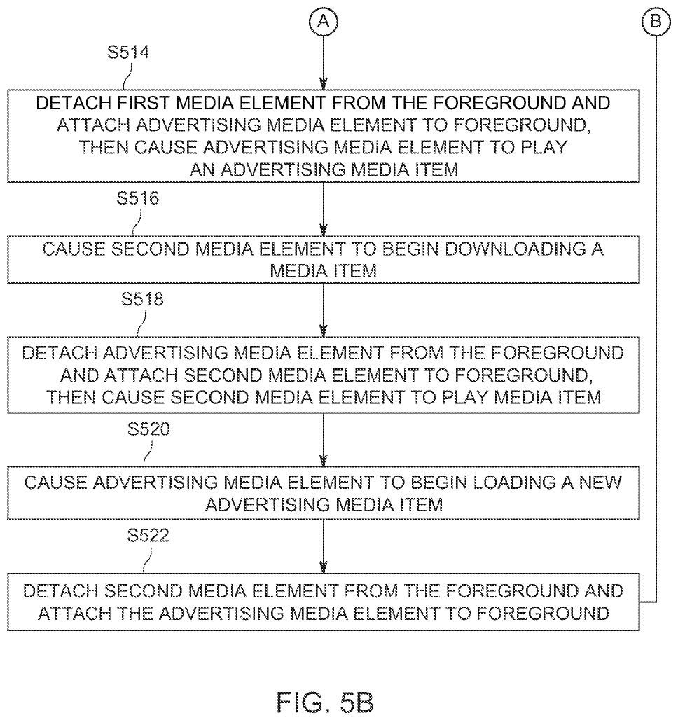

A second method embodying the invention will now be explained with reference to FIGS. 5A & 5B. In this method, first and second media elements are used to play media items similar to how they were played in the method described above for FIG. 4. However, in this method an advertising media element is also used to play an advertising media item to the user before each media item is played.

The method 500 begins and proceeds to step S502. In step S502, the video player instantiates a first media element, a second media element and an advertising media element. Two different media tags are loaded into the first and second media elements, respectively. A tag for an advertising media element is also loaded into the advertising media element. The advertising media element is then attached to the foreground while the first and second media elements remain detached from the foreground.

Note, a variety of other actions could be taken during instantiation of the first media element, the second media element and the advertising media element. For example, volume, resolution and language settings, as well as various other settings could be established for the media elements. In many cases, the first media element, the second media element and the advertising media element would be deliberately configured to all have the same settings.

The method then proceeds to step S504 where a check is performed to determine if the user has taken a play action or issued a play command. If not, the method waits until the user has issued a play command or taken a play action, at which point to the method proceeds to step S506.

In step S506, an advertising program controller 216 of the video player 200 causes the advertising media element to play an advertising media item to the user. This would typically be a video advertisement that is identified in a media tag of the advertising media element.

At some point, the method proceeds to step S508, where the first media element begins downloading into a first playback buffer memory 310 a media item corresponding to the media tag in the first media element. The considerations outlined above in the discussion of step S410 of the method illustrated in FIG. 4 may again come into play here when determining when to proceed to step S508 so that download of the media item into the first playback buffer memory begins.

The aim is to begin the download of the media item into the first playback buffer memory early enough that the media item in the first playback buffer memory is ready to play as soon the advertisement being played by the advertising media element ends. This may, in fact, be easier to determine than in a method as illustrated in FIG. 4 because the user will typically be required to watch all of an advertisement, or at least a specified minimum number of seconds of the advertisement before the user is allowed to begin watching the media item that will be played by the first media element. Thus, it may be possible to determine the point in time at which the advertising media element will end to a greater degree of certainty than in a method as depicted in FIG. 4.

Once play of the advertising media item by the advertising media element ends, whether because the entire advertising media item has been played or because the user watched at least the minimum specified number of seconds of the advertising media item, the method proceeds to step S510. In step S510 the advertising media element is detached from the foreground and the first media element is attached to the foreground. A program controller 204 of the video player 200 then causes the first media element to begin playing the media element that is loading into the first playback buffer memory associated with the first media element.

At some point in time the method then proceeds to step S512 where the advertising media element loads a new advertising media tag for a new advertising media item, and the advertising media item corresponding to that media tag begins downloading into a playback buffer memory associated with the advertising media element. The point at which the method proceeds to step S512 will depend on certain factors as discussed above. The aim is to ensure that as soon as the media item being played by the first media element is halted or ends, play of the advertising media item being downloaded into the playback buffer memory of the advertising media element can instantly begin.

When play of a media item by the first media element ends, the method proceeds to step S514, where the first media element is detached from the foreground and where the advertising media element is again attached to the foreground. The advertising program controller 218 of the video player 200 then causes the advertising media element to begin playing the advertising media item that was loading into the playback buffer memory associated with the advertising media element.

At some point, the method proceeds to step S516 where the second media element begins downloading a media item into a playback buffer memory associated with the second media element. Here again, the aim is to begin downloading the media item into the second playback buffer memory early enough such that the media item can be played immediately by the second media element as soon as the advertising media item being played by the advertising media element stops playing.

When play of the advertising media item by the advertising media element ends, the method proceeds to step S518 where the advertising media element is detached from the foreground and where the second media element is attached to the foreground. The program controller 204 of the video player 200 then causes the second media element to begin playing the media item that was downloading into the second playback buffer memory associated with the second media element.

As before, at some point the method then proceeds to step S520 where the advertising media element loads a new advertising media tag and then begins downloading an advertising media item corresponding to that advertising media tag into the playback buffer memory associated with the advertising media element. As before, the aim is to have enough of the advertising media item downloaded into the playback buffer memory such that playback of the advertising media item can begin as soon as the media item being played by the second media element ends.

When play of the media item by the second media element ends, the method proceeds to step S522 where the second media element is detached from the foreground and where the advertising media element is again attached to the foreground. The method then loops back to step S506 where the advertising program controller causes the advertising media element to begin playing the advertising media item that was downloading into the playback buffer memory associated with the advertising media element.

The method will continue to proceed through steps S506-S522 until the user halts play of all media items, or until the user closes the browser software, or until the user causes the browser to navigate to a new webpage, or until an error in the video player or browser halts play.

In the method described above, both the media items and the advertising media items are loaded in the background. In alternate embodiments, only the video items may be background loaded.

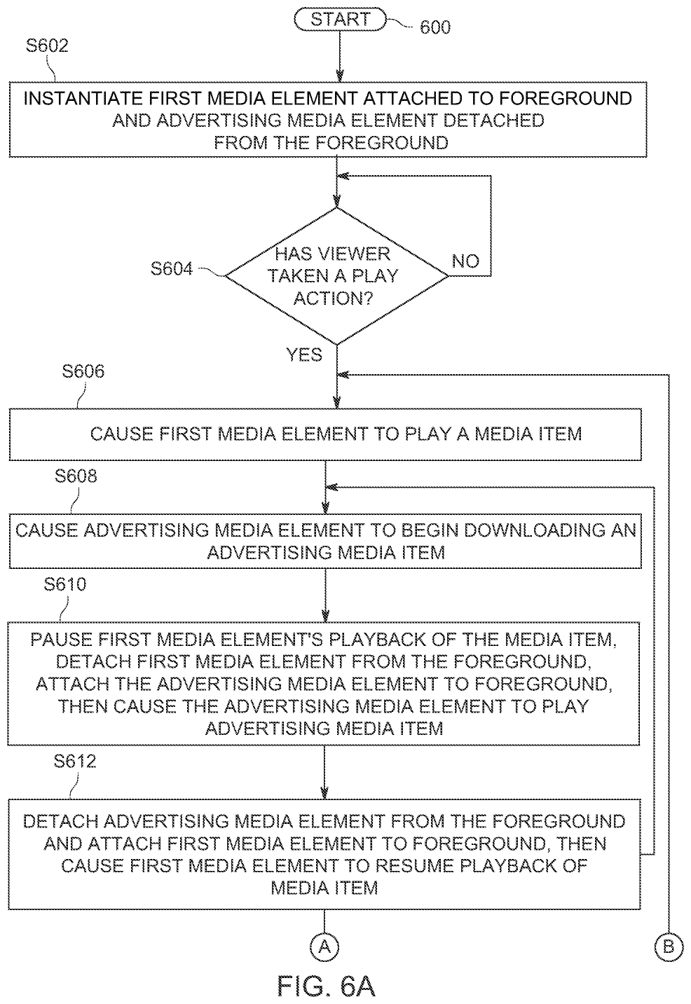

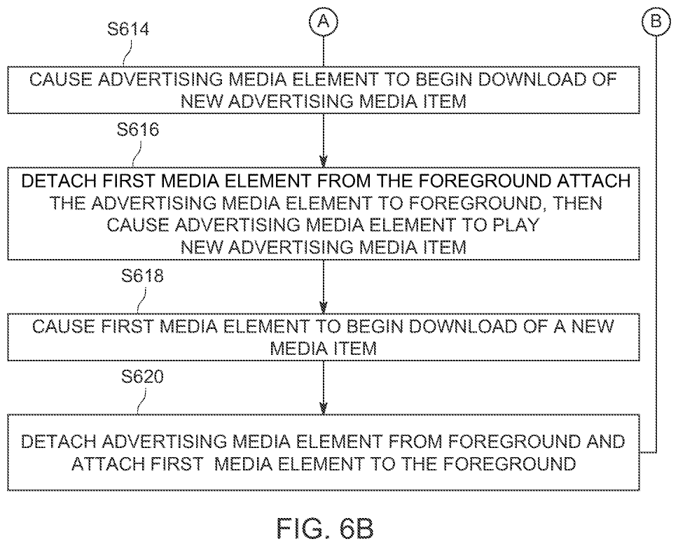

Another method embodying the invention will now be described with reference to FIGS. 6A & 6B. In this method, a video advertisement is played to a user partway through play of a media item that a user has asked to watch.

The method 600 begins and proceeds to step S602 where a video player instantiates a first media element and an advertising media element. All the same instantiation procedures discussed above in connection with the methods illustrated in FIGS. 4 and 5 apply equally here. In step S602, the first media element is attached to the foreground and the advertising media element is detached from the foreground.

The method then proceeds to step S604 where a check is performed to determine if the user has taken a play action or issued a play command. If so, the method proceeds to step S606. If not, the method waits until the user has issued a play command or taken a play action, at which point the method proceeds to step S606.

In step S606 a program controller 204 of the video player 200 causes the first media element to play a media item. At some point, the method proceeds to step S608, where the advertising media element begins downloading an advertising media item into a playback buffer memory associated with the advertising media element. In this instance, however, the point at which the method proceeds to step S608 may be determined based on different considerations than those which were used in the methods illustrated in FIGS. 4, 5A & 5B.

In this method, a media item that is being played by the first media element will be paused partway through, and an advertising media item will be played to the user. Once the advertising media item has finished, or once a predetermined minimum portion of the advertising media item has been played to the user, playback of the media item by the first media element is resumed.

In some instances, it may make sense to play a predetermined number of seconds or minutes of the media item before it is paused and an advertising media item is played. In other instances, there may be natural break points in the media item being played by the first media element. For example, if the media item is a television program that was originally formatted for RF broadcast, the media item may already have natural edited-in break points for advertisements. And those edited-in break points would be known.

For the reasons explained above, there may be various different ways to determine when to pause the playback of the media item by the first media element. But regardless of the method used to determine the pause point, the pause point likely will be known. This allows the video player to determine how far in advance of that pause point to instruct the advertising media element to begin downloading an advertising media item into a playback buffer memory associated with the advertising media element.

When playback of the media item by the first media element reaches a predetermined pause point, the method proceeds to step S610 and play of the media item is paused. The first media element is detached from the foreground and the advertising media element is attached to the foreground. In addition, the advertising program controller causes the advertising media element to begin playing the advertising media item that was downloading.

Once play of the advertising media item ends, or a sufficient portion of the advertising media item has been played to the user, the method proceeds to step S612 where the advertising media element is detached from the foreground and where the first media element is again attached to the foreground. In addition, the program controller 204 of the video player 200 causes the first media element to resume play.

In some embodiments, as when it is desirable to play multiple advertisements to the user while a single lengthy media item is being played, the method would proceed from step S612 back to step S608. Steps S608-S612 could be repeatedly performed as the first media element plays a portion of the media item and as the advertising media element periodically interrupts play of the media item to play an advertising media item. When the last portion of the media element is being played by the first media element, the method ultimately would proceed to step S614, where the advertising media element would begin downloading a new advertising media item that will be played to the user upon completion of the first media item.

Assuming autoplay functionality has been enabled, it would be time for the play of a new media item by the first media element. As a result, the method then proceeds to step S616, where the first media element is detached from the foreground, and where the advertising media element is attached to the foreground. The advertising media element would then begin playing the advertising media element that began downloading in step S614.

As the advertising media item is played to the user in step S616, the method proceeds to step S618 and the program controller 204 of the video player 200 causes the first media element to load a new media tag for a new media item. The first media element then begins downloading the new media item into a playback buffer memory associated with the first media element. Performance of step S618 would begin sufficiently early such that when performance of the advertising media item finishes, play of the new media item by the first media element can immediately begin.

When play of the advertising media item finishes, the method proceeds to step S620, and the advertising media element is detached from the foreground and the first media element is attached to the foreground. The method then loops back to step S606, where the first media element begins play of the new media item to the user.

Steps S606-S620 would continue to be performed until the user halts all play of media items by the video player, or until the user closes the browser software application, or until the user instructs the browser to navigate to a new webpage, or until an error in the video player or the browser halts play.

In each of the methods described above, loading of a new media item into a playback buffer memory may occur as an existing media item is being played/displayed to a user. It is important, however, to ensure that downloading of the new media item not impair the play or display of the existing media item. This is particularly true where the available downloading bandwidth is not large, and where downloading the data that comprises the new media item may delay downloading and play of the existing media item.

For all the above reasons, the video player may choose not to download a new media item while an existing media item is playing, because there is not sufficient bandwidth to do so and still maintain high quality playing of the existing media item. Also, the video player may need to periodically stop and start the downloading of the new media item to prevent the amount of buffered data for the existing media item from becoming too small.

Also, as mentioned above, some browser software applications will allow the autoplay of multiple media items once a user has issued a play command. The methods described above can be performed when those browsers are in use.

However, other browsers will only allow the play of a single media item when the user issues a play command. If that is the case, it may be impossible to perform the methods described above, which involve the autoplay of multiple media items after issuance of a single play command by the user.

Because browsers differ in what they will allow, the video player software application must be capable of operating in multiple different modes. In other words, if a browser will not allow the autoplay of multiple media items after issuance of a single play command, the video player must be capable of defaulting to an alternate play mode that does not involve the autoplay of multiple media items.

In some embodiments, the video player software application may run a test on the browser to determine if the browser will allow autoplay of multiple media items when the video player is first instantiated as part of a webpage. Depending on the results of that test, the video player will then configure itself for either single play mode or autoplay mode.

A related issue is how the video player is controlled by the HTML code of a webpage that instantiates the video player. Website publishers and designers are presently not used to having a video player operate as described above, where background loading occurs. Ideally, the way in which website designers incorporate the video player into a webpage, and the way in which the code controls the video player and uses data and information reported by the video player should remain essentially the same as before.

That said, it is also desirable to provide website developers with the ability to control certain aspects of the background loading, if they so desire. For this reason, in some embodiments, the API 202 of the video player 200 may allow the website developer to control how background loading is performed. This could include simply allowing the website developer to turn background loading on and off. It may be possible for the website developer to control sizes of the playback buffer memories. The website developer may also have the ability to control how the decision is made to initiate background loading while a current media item is still playing. This would correspond to when to advance the method illustrated in FIG. 4 to steps S410 and/or S416.

A website developer might also be capable of configuring rules relating to the play of an existing media item and the downloading of the next media item to ensure that play of the existing media item is not impaired. This could include limiting the download speed of the background media item, and stopping and starting the downloading of a background media item based on an amount of data contained in the playback buffer memory being used to play the existing media item, as well as various other factors.

A website developer may also be capable of configuring the video player with respect to what is considered a user issued play command. Of course, what is considered a user issued play command might be limited by the browser's rules and capabilities. However, the video player might be further configurable within the bounds allowed by the browser that instantiates the video player.

As mentioned above, when a media element of a video player is loading and playing a media item, the video player may report various activities via its API 202. This could include a loading/downloading status or degree/amount of download completion, a time of play, a time to completion of play, as well as a variety of other items. In the past, this information was reported only from the media element attached to the foreground that was downloading and/or playing a media item. In the methods described above, however, there may be multiple media elements that are actively performing tasks at the same time. For example, a media element attached to the foreground and one or more media elements not attached to the foreground may be downloading media items at the same time. There must be some scheme in place to handle reporting of such events and information from media elements that are not presently attached to the foreground.

In some embodiments, any information or events that would normally be reported via the API 202 for media elements that are not attached to the foreground are simply added to a queue maintained for that media element. When such a media element is later attached to the foreground, all the information and events that have been collected in the queue could be reported, in the proper sequence, via the API.

Of course, other ways of handling the reporting of information and events from media elements that are not attached to the foreground could also be performed. For example, if a media element that is not attached to the foreground begins downloading a media element, multiple items of information about the downloading could be compiled in the queue. The last item of information added to the queue might be the fact that download of the media item is complete. In this circumstance, it might not make sense to report all the individual items of information about downloading from the queue when the media element is attached to the foreground. The only important item in the queue is the fact that the media item is fully downloaded. Thus, the information reported via the API when a media element is attached to the foreground may not include all the items that were previously placed in the queue for that media element. Instead, only a selected few items from the queue that summarize the current status of the media element may be reported.

Also, in some embodiments, information or events that occur for a media element in the background might be reported via the API as they occur. For example, it may be desirable to report via the API that a media item of a media element not attached to the foreground has finished loading into a playback buffer memory.

Because the methods discussed above involve the use of multiple media elements, it also is helpful to have a way to synchronize the basic player settings across all media elements. Things like volume, resolution, language, etc. This could be accomplished by maintaining a single video player model 203 for the video player 200 that include settings that should be common across all media elements. The relevant settings of the media model 304 within each media element 300 would then be synchronized with the settings that exist in the video player model 203. If a change is made to one of those settings in the video player model 203, the corresponding setting also would be changed to the new value in each of the media models 304 in the media elements 300.

The present invention may be embodied in methods, apparatus, electronic devices, and/or computer program products. Accordingly, the invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

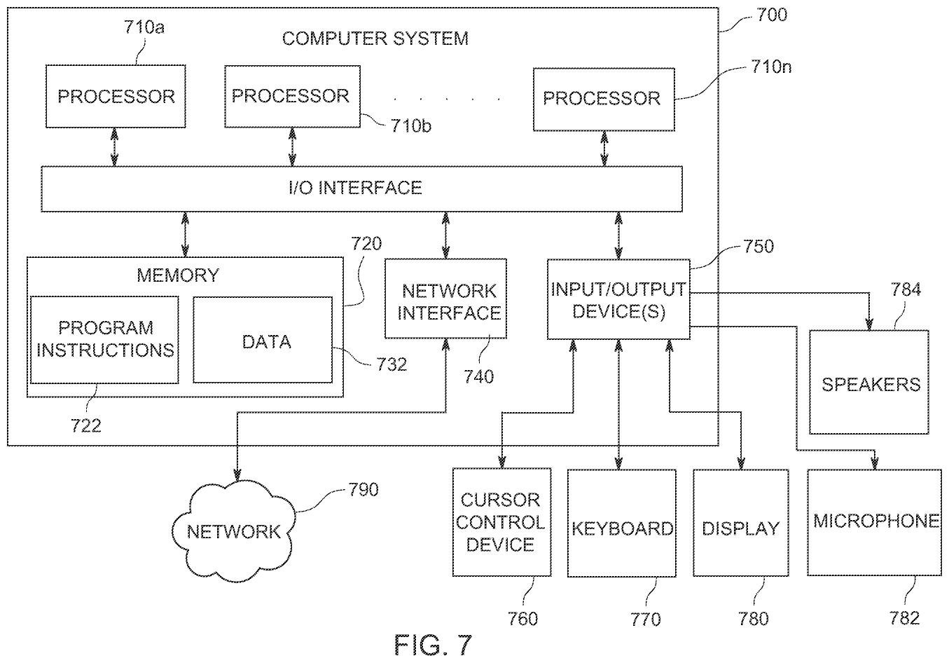

FIG. 7 depicts a computer system 700 that can be utilized in various embodiments of the present invention to implement the invention according to one or more embodiments. The various embodiments as described herein may be executed on one or more computer systems, which may interact with various other devices. One such computer system is the computer system 700 illustrated in FIG. 7. The computer system 700 may be configured to implement the methods described above. The computer system 700 may be used to implement any other system, device, element, functionality or method of the above-described embodiments. In the illustrated embodiments, the computer system 700 may be configured to implement the disclosed methods as processor-executable executable program instructions 722 (e.g., program instructions executable by processor(s) 710) in various embodiments.

In the illustrated embodiment, computer system 700 includes one or more processors 710a-710n coupled to a system memory 720 via an input/output (I/O) interface 730. Computer system 700 further includes a network interface 740 coupled to I/O interface 730, and one or more input/output devices 750, such as cursor control device 760, keyboard 770, display(s) 780, microphone 782 and speakers 784. In various embodiments, any of the components may be utilized by the system to receive user input described above. In various embodiments, a user interface may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, the computer system 700 may be any of various types of devices, including, but not limited to, a personal computer system, desktop computer, laptop, notebook, or netbook computer, a portable computing device, a mainframe computer system, handheld computer, workstation, network computer, a smartphone, a camera, a set top box, a mobile device, a consumer device, video game console, handheld video game device, application server, storage device, a peripheral device such as a switch, modem, router, or in general any type of computing or electronic device.

In various embodiments, the computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the operations and methods described above, such as the methods illustrated by the flowcharts of FIGS. 4-6. In other embodiments, different elements and data may be included.

Those skilled in the art will appreciate that the computer system 700 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method performed by a media player software application present on a page of a website, comprising:
instantiating a first media element that is attached to a foreground of the media player and that includes a first media controller and a first media tag, the first media tag comprising information that can be used to obtain a first media item for playback to a viewer;
instantiating a second media element that is detached from the foreground of the media player and that includes a second media controller and a second media tag, the second media tag comprising information that can be used to obtain a second media item for playback to a viewer;
determining when a viewer of the website has taken a play action that indicates the viewer would like to play a media item;
causing the first media element to begin playing the first media item when it is determined that the viewer has taken a play action, wherein the first media controller reports events relating to the first media item as the first media item is loaded into a first playback buffer memory and as the first media item is played; and
causing the second media element to begin loading the second media item into a second playback buffer memory while the first media element is still playing the first media item.

2. The method of claim 1, wherein the second media element begins loading the second media item into the second playback buffer memory only after the first media element has finished loading the first media item into the first playback buffer memory.

3. The method of claim 1, wherein the second media element begins loading the second media item into the second playback buffer memory at a point in time that will allow enough of the second media item to be loaded into the second playback buffer memory such that the second media item can being playing immediately when the first media item is finished playing.

4. The method of claim 1, wherein when the first media element has finished playing the first media item, the media player:
detaches the first media element from the foreground and attaches the second media element to the foreground;
causes the second media element to begin playing the second media item; and
causes the first media element to load a new media tag, the new media tag comprising information that can be used to obtain a new media item for playback to a viewer.

5. The method of claim 4, wherein the second media controller queues events relating to the second media item while the second media element remains detached from the foreground, and wherein when the second media element is attached to the foreground, the second media controller reports events that were queued for the second media element while the second media element was detached from the foreground.

6. The method of claim 4, wherein the media player also causes the first media element to begin loading the new media item into the first playback buffer memory while the second media element is still playing the second media item.

7. The method of claim 1, further comprising reporting events that are reported from the first or second media controllers while they are attached to the foreground via an Application Programming Interface.

8. The method of claim 1, further comprising instantiating an advertising media element that is detached from the foreground of the media player and that includes an advertising media controller and a first advertising media tag, the first advertising media tag comprising information that can be used to obtain an advertising media item for playback to a viewer.

9. The method of claim 8, wherein during playback of the first media item by the first media element, the video player:
causes the first media element to pause playback of the first media item;
detaches the first media element from the foreground and attaches the advertising media element to the foreground;
causes the advertising media element to play the first advertising media item;
detaches the advertising media element from the foreground and attaches the first media element to the foreground; and
causes the first media element to continue playback of the first media item.

10. The method of claim 9, wherein the advertising media element begins loading the first advertising media item into an advertising playback buffer memory while the first media element is playing the first media item.

11. The method of claim 9, wherein after the advertising media element is detached from the foreground after the first advertising media item has played, the advertising media element loads a new advertising media tag.

12. The method of claim 11, wherein the advertising media element begins loading a new advertising media item into the advertising playback buffer memory while the first media element is still playing the first media item.

13. A system for playing media items, comprising:
means for instantiating a first media element that is attached to a foreground of a media player and that includes a first media controller and a first media tag, the first media tag comprising information that can be used to obtain a first media item for playback to a viewer;
means for instantiating a second media element that is detached from the foreground of the media player and that includes a second media controller and a second media tag, the second media tag comprising information that can be used to obtain a second media item for playback to a viewer;
means for determining when a viewer of the website has taken a play action that indicates the viewer would like to play a media item;
means for causing the first media element to begin playing the first media item when it is determined that the viewer has taken a play action, wherein the first media controller reports events relating to the first media item as the first media item is loaded into a first playback buffer memory and as the first media item is played; and
means for causing the second media element to begin loading the second media item into a second playback buffer memory while the first media element is still playing the first media item.

14. A system for playing media items, comprising:
one or more processor that are configured to perform a method comprising the steps of:
instantiating a first media element that is attached to a foreground of the media player and that includes a first media controller and a first media tag, the first media tag comprising information that can be used to obtain a first media item for playback to a viewer;
instantiating a second media element that is detached from the foreground of the media player and that includes a second media controller and a second media tag, the second media tag comprising information that can be used to obtain a second media item for playback to a viewer;
determining when a viewer of the website has taken a play action that indicates the viewer would like to play a media item;
causing the first media element to begin playing the first media item when it is determined that the viewer has taken a play action, wherein the first media controller reports events relating to the first media item as the first media item is loaded into a first playback buffer memory and as the first media item is played; and
causing the second media element to begin loading the second media item into a second playback buffer memory while the first media element is still playing the first media item.

15. The system of claim 14, wherein the one or more processors are also configured such that the second media controller queues events relating to the second media item while the second media element remains detached from the foreground, and such that when the second media element is attached to the foreground, the second media controller reports events that were queued while the second media element was detached from the foreground.

16. A non-transitory, computer readable medium bearing instructions that, when performed by one or more processors, perform a method comprising the steps of:
instantiating a first media element that is attached to a foreground of a media player and that includes a first media controller and a first media tag, the first media tag comprising information that can be used to obtain a first media item for playback to a viewer;
instantiating a second media element that is detached from the foreground of the media player and that includes a second media controller and a second media tag, the second media tag comprising information that can be used to obtain a second media item for playback to a viewer;
determining when a viewer of a website upon which the first and second media elements have been instantiated has taken a play action that indicates the viewer would like to play a media item;
causing the first media element to begin playing the first media item when it is determined that the viewer has taken a play action, wherein the first media controller reports events relating to the first media item as the first media item is loaded into a first playback buffer memory and as the first media item is played; and
causing the second media element to begin loading the second media item into a second playback buffer memory while the first media element is still playing the first media item.

17. The non-transitory, computer readable medium of claim 16, wherein the instructions also cause the one or more processors to perform the method such that the second media element begins loading the second media item into the second playback buffer memory only after the first media element has finished loading the first media item into the first playback buffer memory.

18. The non-transitory, computer readable medium of claim 16, wherein the instructions also cause the one or more processors to perform the method such that the second media element begins loading the second media item into the second playback buffer memory at a point in time that will allow enough of the second media item to be loaded into the second playback buffer memory such that the second media item can being playing immediately when the first media item is finished playing.

19. The non-transitory, computer readable medium of claim 16, wherein the instructions also cause the one or more processors to perform the method such that when the first media element has finished playing the first media item:
the first media element is detached from the foreground and the second media element is attached to the foreground;
second media element is caused to begin playing the second media item; and
the first media element is caused to load a new media tag, the new media tag comprising information that can be used to obtain a new media item for playback to a viewer.

20. The non-transitory, computer readable medium of claim 19, wherein the instructions also cause the one or more processors to perform the method such that the second media controller queues events relating to the second media item while the second media element remains detached from the foreground, and such that when the second media element is attached to the foreground, the second media controller reports events that were queued for the second media element while the second media element was detached from the foreground.

21. The non-transitory, computer readable medium of claim 19, wherein the instructions also cause the one or more processors to perform the method such that the first media element is caused to begin loading the new media item into the first playback buffer memory while the second media element is still playing the second media item.

22. The non-transitory, computer readable medium of claim 16, wherein the instructions also cause the one or more processors to perform the method such that the method further comprises reporting events that are reported from the first or second media controllers of the corresponding first and second media elements while they are attached to the foreground via an Application Programming Interface.

23. The non-transitory, computer readable medium of claim 22, wherein the instructions also cause the one or more processors to perform the method such that the method further comprises reporting at least some of the events that are reported from the first or second media controllers of the corresponding first and second media elements while they are attached to the background via an Application Programming Interface.

24. The non-transitory, computer readable medium of claim 16, wherein the instructions also cause the one or more processors to perform the method such that the method further comprises instantiating an advertising media element that is detached from the foreground of the media player and that includes an advertising media controller and a first advertising media tag, the first advertising media tag comprising information that can be used to obtain an advertising media item for playback to a viewer.

25. The non-transitory, computer readable medium of claim 24, wherein the instructions also cause the one or more processors to perform the method such that during playback of the first media item by the first media element, the method further comprises:
causing the first media element to pause playback of the first media item;
detaching the first media element from the foreground and attaching the advertising media element to the foreground;
causing the advertising media element to play the first advertising media item;
detaching the advertising media element from the foreground and attaching the first media element to the foreground; and
causing the first media element to resume playback of the first media item.

26. The non-transitory, computer readable medium of claim 25, wherein the instructions also cause the one or more processors to perform the method such that the advertising media element begins loading the first advertising media item into an advertising playback buffer memory while the first media element is playing the first media item.

27. The non-transitory, computer readable medium of claim 25, wherein the instructions also cause the one or more processors to perform the method such that after the advertising media element is detached from the foreground after the first advertising media item has played, the advertising media element loads a new advertising media tag.

28. The non-transitory, computer readable medium of claim 27, wherein the instructions also cause the one or more processors to perform the method such that the advertising media element begins loading a new advertising media item into the advertising playback buffer memory while the first media element is still playing the first media item.
